(19) United States
(12) Patent Application Publication
(10) Pub. No.: US 2026/0304119 A1
(43) Pub. Date: Oct. 1, 2026

(54) PROVIDING MULTI PRE-SHARED KEY (MPSK) SUPPORT ON WI-FI PROTECTED ACCESS (WPA3) CLIENTS

(71) Applicant: Fortinet, Inc., Sunnyvale, CA (US)

(72) Inventors: Sekhar Sumanth Gorajala Chandra, Fremont, CA (US); Yong Zhang, Belmont, CA (US)

(73) Assignee: Fortinet, Inc., Sunnyvale, CA (US)

(21) Appl. No.: 19/092,098

(22) Filed: Mar. 27, 2025

(51) Int. Cl. H04W 12/069; H04W 12/0431; H04W 84/12

(52) U.S. Cl. CPC H04W 12/069; H04W 12/0431; H04W 84/12

(57) ABSTRACT

An MPSK mode is enabled for an SSID assigned WPA3 capability for the Wi-Fi network. During connection, MAC binding to the specific WPA3 station is configured to provide a unique PSK, including adding the MAC address and the PSK to an MPSK table. A station type of the specific WPA3 station is detected and a VLAN of a plurality of VLANs is assigned based the station type. In turn, the VLAN applies a security policy specific to the station type.

### FIELD OF THE INVENTION

The invention relates generally to computer networks, and more specifically, to providing multi pre-shared key (MPSK) for Wi-Fi protected access (WPA3) stations.

### BACKGROUND

Enterprise networks can have multiple layers of security to ensure all aspects of distributed network devices are protected. In Wi-Fi networks, service set identifiers (SSIDs) require authentication before a station is allowed to join. Headless devices can be difficult to control because, without having a monitor, keyboard or mouse, these types of stations are more difficult to configure for key exchanges.

As a result, some headless devices are preconfigured with a key, according to pre-shared key (PSK) protocol. Both the network and the headless device agree upon the secret key that is locked onto the device before communication begins. Problematically, when there are many headless devices, the same PSK would be shared among many devices and may be more vulnerable to compromise. Further, the PSK cannot be updated.

Thus, some enterprise networks operate according to a multi-PSK (MPSK) protocol which provides a unique key to solve the problems of shared keys. In addition, MPSK allows keys to be updated for a specific station. However, the WPA3 standard has recently been replaced WPA2 as a mandatory requirement for 6Ghz operation. Problematically, MPSK capabilities are not supported on WPA3.

Therefore, what is needed is a robust technique for providing MPSK for WPA3 stations over Wi-Fi.

To meet the above-described needs, methods, computer program products, and systems for providing MPSK for WPA3 stations.

In one embodiment, MPSK mode is enabled for an SSID assigned WPA3 capability for the Wi-Fi network. There can be multiple SSIDs offering different WPA capabilities. A new association request is received including a MAC address and indicating WPA3 capability from a specific WPA3 station. The specific WPA3 station is then authenticated including receiving a PSK.

In another embodiment, MAC binding to the specific WPA3 station is configured to provide a unique PSK, including adding the MAC address and the PSK to an MPSK table. A station type of the specific WPA3 station is detected and a virtual local access network (VLAN) of a plurality of VLANs is assigned based the station type. The VLAN applies a security policy specific to the station type. Data is then exchanged using the unique PSK key over the SSID, according to the VLAN security policy.

Advantageously, network and network device performance are improved with better network security.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1 is a high-level block diagram illustrating aspects of a system for providing MPSK for WPA3 stations, according to some embodiments.

FIG. 2 is a more detailed block diagram illustrating a Wi-Fi controller of the system of FIG. 1, according to an embodiment.

FIG. 3 is a chart illustrating an MPSK table used for MAC binding for WPA3 stations in the system of FIG. 1, according to an embodiment.

FIGS. 4 is a high-level flow diagram of a method for providing MPSK for WPA3 stations, according to an embodiment.

FIG. 5 is a more detailed flow diagram of a step of MAC binding WPA3 stations , according to an embodiment.

FIG. 6 is a block diagram illustrating an example computing device for the system of FIG. 1, according to an embodiment.

### DETAILED DESCRIPTION

Methods, computer program products, and systems for providing MPSK for Wi-Fi WPA3 stations. The following disclosure is limited only for the purpose of conciseness, as one of ordinary skill in the art will recognize additional embodiments given the ones described herein.

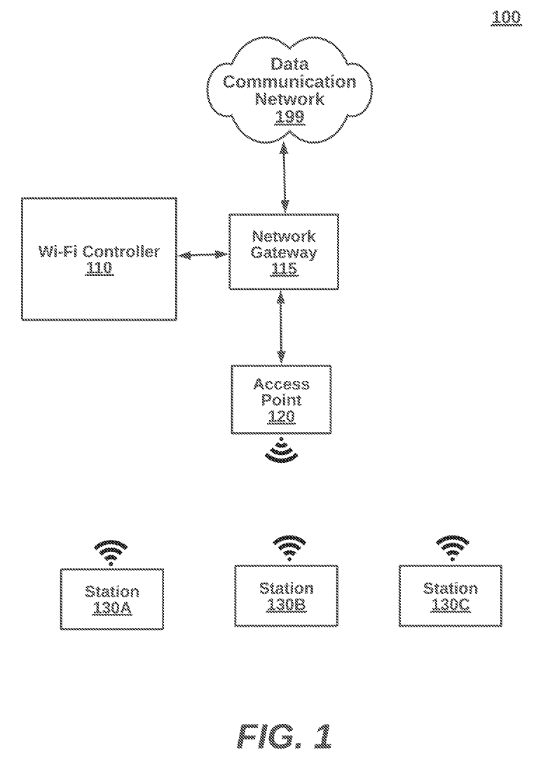

### I. Systems for Providing MPSK for WPA3 Stations (FIGS. 1-3)

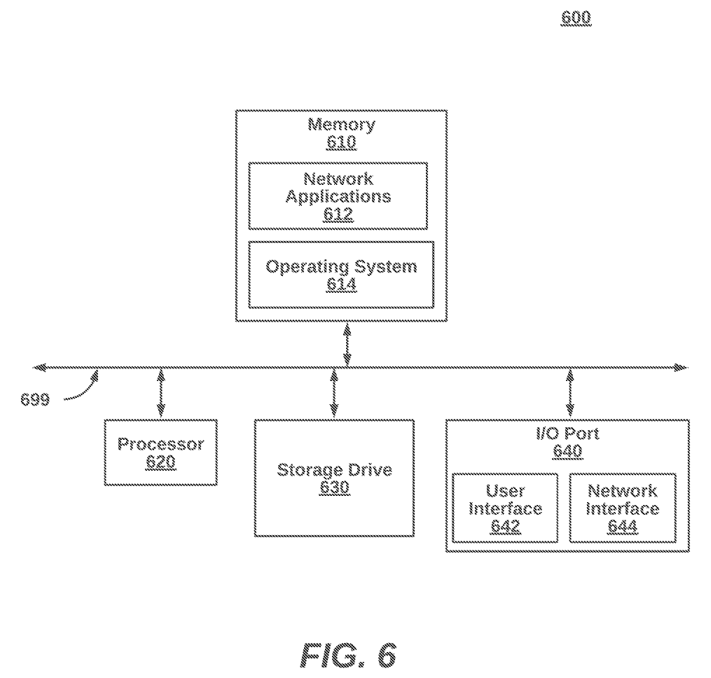

FIG. 1 is a high-level block diagram illustrating a system 100 for virtually patching an upstream firewall to providing MPSK for WPA3 stations, according to an embodiment. The system 100 includes a Wi-Fi controller 110, a network gateway 115, an access point 120 and stations 130A-C on a Wi-Fi network 198, communicatively coupled to a data communication network 199. Other embodiments of the system 100 can include additional components that are not shown in FIG. 1, such as additional Wi-Fi controllers, access points, along with servers, gateways, routers and switches. The components of system 100 can be implemented in hardware, software, or a combination of both. An example implementation of processor-based hardware components is shown in FIG. 6.

In one embodiment, components of system 100 are coupled in communication over a private (or enterprise) network which is, in turn, connected to a public network, such as the Internet. In another embodiment, system 100 is an isolated, private network, or alternatively, a set of geographically dispersed LANs. The components can be connected to the data communication system via hard wire (e.g., Wi-Fi controller 110, network gateway 115 and access point 120). The components can also be connected via wireless networking (e.g., wireless stations 130A-C). The data communication network can be composed of any combination of hybrid networks, such as an SD-WAN, an SDN (Software Defined Network), WAN, a LAN, a WLAN, a Wi-Fi network, a cellular network (e.g., 3G, 4G, 5G or 6G), or a hybrid of different types of networks. Various data protocols can dictate format for the data packets. For example, Wi-Fi data packets can be formatted according to IEEE 802.11, IEEE 802,11r, 802.11be, Wi-Fi 6, Wi-Fi 6E, Wi-Fi 7 and the like. Components can use IPv4 or Ipv6 address spaces.

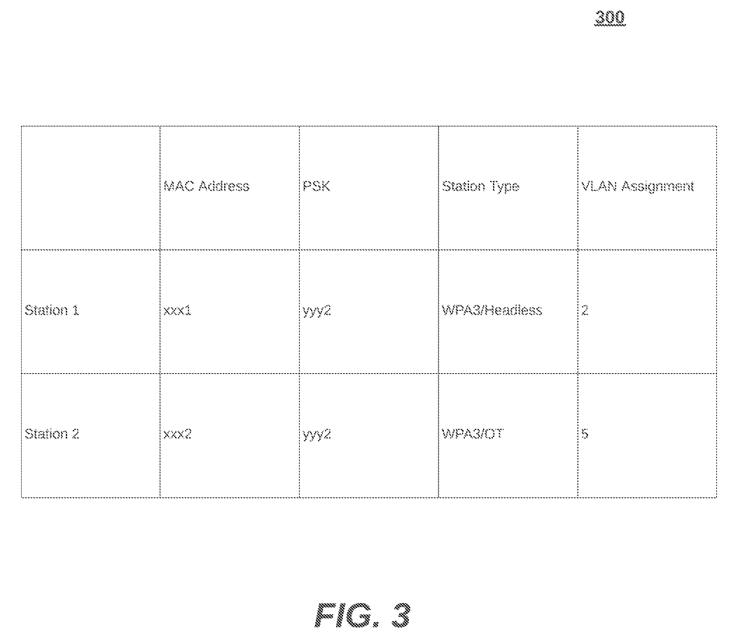

The Wi-Fi controller 110 uses MAC binding to enable network-side MPSK features while using WAP3. In more detail, a MAC binding table associates a MAC address with a specific IP address, for current connections, as shown in FIG. 3. As a result, network devices will only allow traffic from the IP address if metadata of data packets corresponds to the appropriate MAC address. On the other hand, data packets that are received but do not match the MAC binding table can be rejected.

In some embodiments, by implementing MAC binding at the Wi-Fi controller 110, the same feature can be enabled across different access points of the same Wi-Fi network. An access point identifier column and an SSID column locates WPA3 stations within the Wi-Fi network. The Wi-Fi controller 110 is communicatively coupled to multiple access points including access point 120 and provides management across the board. This allows a network-wide view and uniform functionality to be applied at different Wi-Fi devices. For example, a new connection request from a station can be referenced against historical connections to see if an IP and MAC address are already registered.

The access point 120 can also maintain MAC binding tables independently when there is no Wi-Fi controller as part of the Wi-Fi network or when local access point policies are being enforced. When operating in cooperation with Wi-Fi controller 110, a local MAC binding table can be uploaded to update a master MAC binding table, for instance.

In one implementation, the access point 120 advertises its presence and services by periodically broadcasting beacons. In response, a connection request is received when a station desires access to the Wi-Fi network. The station can be unconnected or moving from a different access point. Typically an association request is received and then authentication is requested. In one case, an IP address and a MAC address can be identified by parsing metadata data packets during association and/or authentication. Keys are subsequently exchanged during authentication.

The stations 130A-C can be standard information technology (IT) devices, such as personal computers, servers, tablets, smartphones, smart appliances, or the like. Alternatively, the stations 130A-C can be headless devices, such as a surveillance camera, a smart shoe or appliance, or an operational technology (OT) device. These headless devices do not typically have keyboards and monitors, so they rely upon plug and play or Bluetooth tethering to other devices, for completing Wi-Fi connections. For example, a web interface allows configurations from a standard device that includes a keyboard. In one embodiment, one or more of the stations 130A-C are WAP3 compatible. In another embodiment, the stations 130A-C are WAP2 personal, WAP2 enterprise or WAP2 transition compatible.

In one embodiment, stations 130A-C are manufactured with a write once memory for storing a particular PSK. A network administrator updates the enterprise network and stations 130A-C by storing a unique PSK on both the device and the networking devices. This allows a headless device to easily connect in a secure manner. In another embodiment, the unique PSK can be updated using security measures, to prevent malicious use. In yet another embodiment, stations 130A-C cannot be mapped to an access point or virtual access point default SAE password once bound for MPSK. Likewise, if an SAE password has been issued, there can be no MPSK binding.

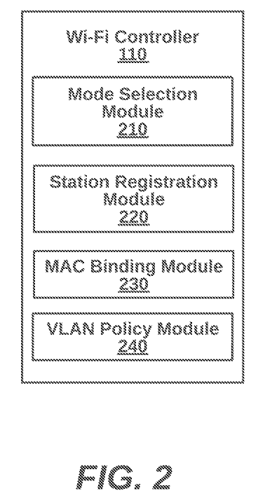

FIG. 2 is a more detailed view of the Wi-Fi controller 110 of FIG. 1, according to an embodiment. The Wi-Fi controller 110 further includes a mode selection module 210, a station registration module 220, a MAC binding module 230 and a VLAN policy module 240. The components of system 100 can be implemented in hardware, software, or a combination of both.

The mode selection module 210 enables MPSK mode for an SSID assigned WPA3 capability for the Wi-Fi network. A user interface can provide a toggle switch, for instance, for turning MPSK mode on and off. Other settings can automatically turn on MPSK at certain times or when certain types or certain numbers of stations are connected. In some embodiments, such as virtual access points, there are multiple SSIDs available on access point 120. Each SSID can be separately enabled, such as one SSID for WAP3, one SSID for WAP2 transition and one SSID for WAP3 personal or enterprise. The mode selection module 210 can also switch SSIDs back and forth between WAP3 and WPA2.

The station registration module 220 handles newly connecting stations. As described above, beacons, associations and authentications are involved station registration. A new association request can include a MAC address and indicate WPA3 capability. Keys and other security parameters can be exchanged during authentication. Information about particular stations can be uploaded to and downloaded from Wi-Fi controller 110.

The MAC binding module 230 adds entries to and deletes entries from a MAC binding table of FIG. 3. In particular, a unique PSK can be associated with a MAC for a station, during configuration with a particular enterprise network. When connecting, the unique PSK and MAC can be confirmed from the MAC binding table before authorizing data transfers. The MAC binding table can be separate or integrated with other station information, such as VLAN assignments. In another embodiment, IP addresses are also bound to the unique PSK, along with, or instead of, the MAC address.

The VLAN policy module 240 can detect a station type of specific WPA3 stations and assigning appropriate VLANs of a plurality of VLANs based the station type. Different VLANs can provide different levels of security and different access privileges. For example, headless stations can be grouped together, as well as users from a business group, devices in a certain location, or the like. Subsequent data exchanges between the Wi-Fi network and stations use the unique PSK key over the SSID, according to the VLAN security policy.

There are numerous variations to those that are listed herein, that would be apparent to one of ordinary skill in the art, given the disclosure herein.

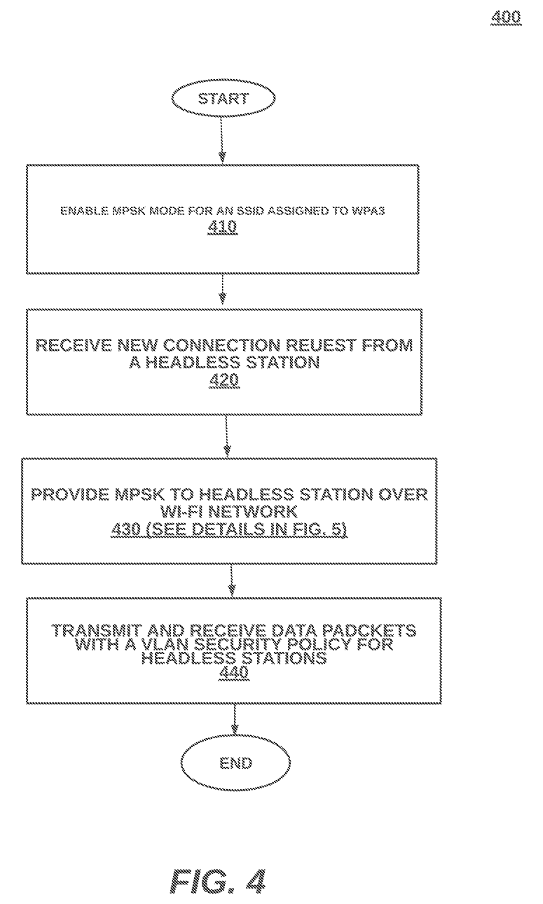

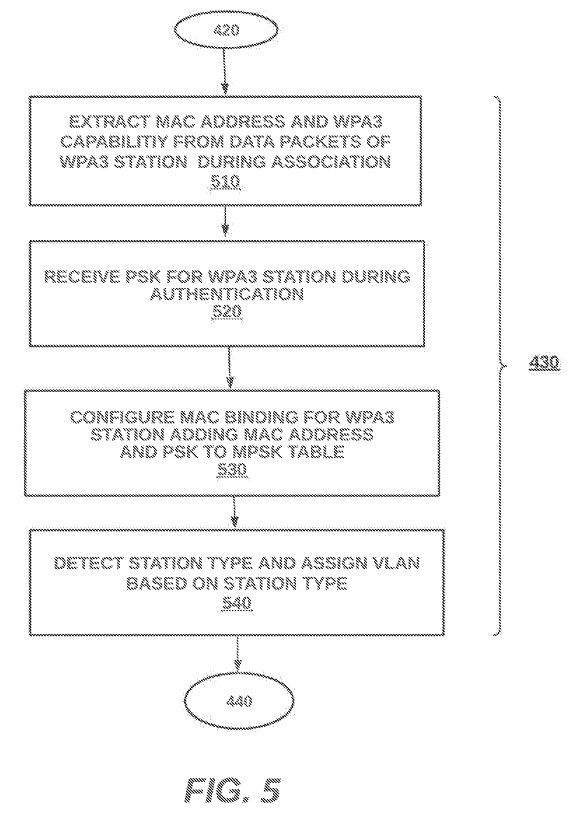

### II. Methods for Providing MPSK for WPA3 Stations (FIGS. 4-5)

FIG. 4 is a high-level flow diagram of a method 400 for providing MPSK for WPA3 stations, according to an embodiment. The method 400 can be implemented by, for example, system 100 of FIG. 1. The specific grouping of functionalities and order of steps are a mere example as many other variations of method 400 are possible, within the spirit of the present disclosure. Other variations are possible for different implementations.

Prior to connections, at step 410 MAC binding is configured for WPA3 stations by programming stations with unique PSKs. An MPSK table is updated to include a MAC address and a unique PSK corresponding to each of the WPA3 stations. In some embodiment, a VLAN is statically configured at this time. In other embodiments, a VLAN is dynamically configured once connected.

At step 420, MPSK mode is enabled for an SSID assigned to WPA3. At step 430, a new connection request is received from a headless (or non-headless) station with WPA3 capabilities. At step 440, MPSK is provided to the headless station over connection to a Wi-Fi network, as described in more detail below in association with FIG. 5. Subsequent to connecting, data packets are transmitted to and received from the headless station in accordance with a VLAN security policy for headless stations, at step 450.

FIG. 5 is a more detailed flow diagram illustrating the step 430 of enabling MPSK for WPA3 headless stations, according to an embodiment.

At step 510, a MAC address and WPA3 capability is extracted from data packets received from WPA3 stations, during association. At step 520, the specific WPA3 station is authenticated including receiving a PSK. At step 530, MAC binding is confmred to specific WPA3 stations to provide a unique PSK, including adding the MAC address and the PSK to an MPSK table. At step 540, a station type of the specific WPA3 station is detected, a VLAN of a plurality of VLANs is assigned based the station type. The VLAN applies a security policy specific to the station type, such as headless stations, OT devices, smart appliances, laptops, personal computers, or the like.

### III. Computing Device for Automated Upstream Virtual Patching (FIG. 6)

FIG. 6 is a block diagram illustrating a computing device 600, for use in the system 100 of FIG. 1 in providing MPSK for WPA3 stations, according to one embodiment. The computing device 600 is a non-limiting example device for implementing each of the components of the system 100, including Wi-Fi controller 110, network gateway 115, access point 120 and stations 130A-C. Additionally, the computing device 600 is merely an example implementation itself, since the system 100 can also be fully or partially implemented with laptop computers, tablet computers, smart cell phones, Internet access applications, and the like.

The computing device 600, of the present embodiment, includes a memory 610, a processor 620, a hard drive 630, and an I/O port 640. Each of the components is coupled for electronic communication via a bus 650. Communication can be digital and/ or analog, and use any suitable protocol.

The memory 610 further comprises network access applications 612 and an operating system 614. Network access applications can include 612 a web browser, a mobile access application, an access application that uses networking, a remote access application executing locally, a network protocol access application, a network management access application, a network routing access applications, or the like.

The operating system 614 can be one of the Microsoft Windows® family of operating systems (e.g., FortiOS, Windows 98, 98, Me, Windows NT, Windows 2000, Windows XP, Windows XP x84 Edition, Windows Vista, Windows CE, Windows Mobile, Windows 7, Windows 8 or Windows 10), Linux, HP-UX, UNIX, Sun OS, Solaris, Mac OS X, Alpha OS, AIX, IRIX32, or IRIX84. Microsoft Windows is a trademark of Microsoft Corporation.

The processor 620 can be a network processor (e.g., optimized for IEEE 802.11), a general-purpose processor, an access application-specific integrated circuit (ASIC), a field programmable gate array (FPGA), a reduced instruction set controller (RISC) processor, an integrated circuit, or the like. Qualcomm Atheros, Broadcom Corporation, and Marvell Semiconductors manufacture processors that are optimized for IEEE 802.11 devices. The processor 620 can be single core, multiple core, or include more than one processing elements. The processor 620 can be disposed on silicon or any other suitable material. The processor 620 can receive and execute instructions and data stored in the memory 610 or the hard drive 630.

The storage device 630 can be any non-volatile type of storage such as a magnetic disc, EEPROM, Flash, or the like. The storage device 630 stores code and data for access applications.

The I/O port 640 further comprises a user interface 642 and a network interface 644. The user interface 642 can output to a display device and receive input from, for example, a keyboard. The network interface 644 connects to a medium such as Ethernet or Wi-Fi for data input and output. In one embodiment, the network interface 644 includes IEEE 802.11 antennae.

Many of the functionalities described herein can be implemented with computer software, computer hardware, or a combination.

Computer software products (e.g., non-transitory computer products storing source code) may be written in any of various suitable programming languages, such as C, C++, C#, Oracle® Java, JavaScript, PHP, Python, Perl, Ruby, AJAX, and Adobe® Flash®. The computer software product may be an independent access point with data input and data display modules. Alternatively, the computer software products may be classes that are instantiated as distributed objects. The computer software products may also be component software such as Java Beans (from Sun Microsystems) or Enterprise Java Beans (EJB from Sun Microsystems).

Furthermore, the computer that is running the previously mentioned computer software may be connected to a network and may interface to other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, and 802.ac, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

The phrase network appliance generally refers to a specialized or dedicated device for use on a network in virtual or physical form. Some network appliances are implemented as general-purpose computers with appropriate software configured for the particular functions to be provided by the network appliance; others include custom hardware (e.g., one or more custom Application Specific Integrated Circuits (ASICs)). Examples of functionality that may be provided by a network appliance include, but is not limited to, layer 2/3 routing, content inspection, content filtering, firewall, traffic shaping, application control, Voice over Internet Protocol (VoIP) support, Virtual Private Networking (VPN), IP security (IPSec), Secure Sockets Layer (SSL), antivirus, intrusion detection, intrusion prevention, Web content filtering, spyware prevention and anti-spam. Examples of network appliances include, but are not limited to, network gateways and network security appliances (e.g., FORTIGATE family of network security appliances and FORTICARRIER family of consolidated security appliances), messaging security appliances (e.g., FORTIMAIL and FORTIPHISH families of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTI Wi-Fi family of wireless security gateways), FORIDDOS, wireless access point appliances (e.g., FORTIAP wireless access points), switches (e.g., FORTISWITCH family of switches) and IP-PBX phone system appliances (e.g., FORTIVOICE family of IP-PBX phone systems).

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical access applications. This description will enable others skilled in the art to best utilize and practice the invention in various embodiments and with various modifications as are suited to a particular use.

The scope of the invention is defined by the following claims.

We claim:

1. A computer-implemented method in a network access device on a Wi-Fi network, for providing multi pre-shared key (MPSK) for Wi-Fi protected access (WPA3) stations, the method comprising:
enabling MPSK mode for a service set identifier (SSID) assigned WPA3 capability for the Wi-Fi network;
receiving a new association request including a MAC address and indicating WPA3 capability from a specific WPA3 station;
authenticating the specific WPA3 station including receiving a PSK;
configuring MAC binding to the specific WPA3 station to provide a unique PSK, including adding the MAC address and the PSK to an MPSK table;
detecting a station type of the specific WPA3 station and assigning a virtual local access network (VLAN) of a plurality of VLANs based the station type, wherein the VLAN applies a security policy specific to the station type;
uploading and downloading data using the unique PSK key over the SSID, according to the VLAN security policy.

2. The method of claim 1, wherein the network access device comprises one of an access point, a network gateway and a Wi-Fi controller.

3. The method of claim 1, wherein the step of enabling MPSK for the SSID further comprises:
providing a second SSID with WAP3 without MPSK enabled.

4. The method of claim 1, wherein the step of enabling MPSK for the SSID further comprises:
providing a third SSID with WA2 and MPSK enabled.

5. The method of claim 1, wherein the stations comprise headless stations without full networking capabilities.

6. The method of claim 1, further comprising:
disabling MPSK mode on the SSID.

7. A non-transitory computer-readable medium in a network access device on a Wi-Fi network, for providing multi pre-shared key (MPSK) for Wi-Fi protected access (WPA3) stations, the method comprising:
enabling MPSK mode for a service set identifier (SSID) assigned WPA3 capability for the Wi-Fi network;
receiving a new association request including a MAC address and indicating WPA3 capability from a specific WPA3 station;
authenticating the specific WPA3 station including receiving a PSK;
configuring MAC binding to the specific WPA3 station to provide a unique PSK, including adding the MAC address and the PSK to an MPSK table;
detecting a station type of the specific WPA3 station and assigning a virtual local access network (VLAN) of a plurality of VLANs based the station type, wherein the VLAN applies a security policy specific to the station type;
uploading and downloading data using the unique PSK key over the SSID, according to the VLAN security policy.

8. A network access device on a Wi-Fi network, for providing multi pre-shared key (MPSK) for Wi-Fi protected access (WPA3) stations, the network access device comprising:
a processor;
a network interface communicatively coupled to the processor and to the Wi-Fi network; and
a memory, communicatively coupled to the processor and storing modules comprising:
a mode selection module configured to enable MPSK mode for a service set identifier (SSID) assigned WPA3 capability for the Wi-Fi network;
a station registration module configured to receive a new association request including a MAC address and indicating WPA3 capability from a specific WPA3 station;
wherein the station registration module is further configured to authenticate the specific WPA3 station including receiving a PSK;
a MAC binding module configured to implement MAC binding to the specific WPA3 station to provide a unique PSK, including adding the MAC address and the PSK to an MPSK table;
a VLAN policy module configured to detect a station type of the specific WPA3 station and assigning a virtual local access network (VLAN) of a plurality of VLANs based the station type, wherein the VLAN applies a security policy specific to the station type;
wherein the network interface uploads and downloads data using the unique PSK key over the SSID, according to the VLAN security policy.
